(19) United States
(12) Patent Application Publication
(10) Pub. No.: US 2025/0215940 A1
(43) Pub. Date: Jul. 3, 2025

(54) PAD-HOLDING PIN AND SLIDING GUIDE ASSEMBLY, FLOATING BRAKE CALIPER

(71) Applicant: Brembo S.p.A., Curno (IT)

(72) Inventors: Cristian CRIPPA, Curno (IT); Lorenzo NESSI, Curno (IT)

(21) Appl. No.: 19/001,913

(22) Filed: Dec. 26, 2024

(30) Foreign Application Priority Data
Dec. 28, 2023 (IT) 102023000028197

(51) Int. Cl. F16D 55/2265; F16D 55/00; F16D 55/227; F16D 65/00; F16D 65/095

(52) U.S. Cl. CPC F16D 55/22655; F16D 55/227; F16D 65/0056; F16D 65/0068; F16D 65/0087; F16D 65/095; F16D 2055/0008; F16D 2055/0016; F16D 2055/007

(57) ABSTRACT

It is the object of the present invention a pad-holding pin and sliding guide assembly 4, 5 for a brake caliper 1 of the floating type of a disc brake, wherein the brake caliper 1 comprises a caliper body or floating element 2, a bracket or support element 3 configured to be connected to a vehicle,

in which the pad-holding pin and sliding guide assembly 4, 5 is connectable in a fixed manner to the bracket 3 and in a sliding manner to the caliper body 2 to allow for a relative sliding between the caliper body 2 and the bracket 3 along an axial direction A-A, in which the pad-holding pin and sliding guide assembly 4, 5 comprises a pad-holding pin 13, 13′ and a sliding guide 10, 10′ made in separate, reversibly connectable pieces, in which the pad-holding pin 13, 13′ is configured to support at least one brake pad 52, 53 and in which the sliding guide 10, 10′ is at least partially housable in a respective sliding seat 11, 12, in which the respective sliding seat 11, 12 is made in said caliper body 2; in which the pad-holding pin 13, 13′ and the sliding guide 10, 10′ comprise a pin connecting portion 17 and a guide connecting portion 24, respectively, connectable to each other by threaded connection to connect the pad-holding pin and sliding guide assembly 4, 5 in a fixed manner to the bracket 3 by tightening the bracket 3 on axially opposite sides between the pad-holding pin 13, 13′ and the sliding guide 10, 10′ avoiding having connecting threads between the at least one pad-holding pin and sliding guide assembly 4, 5 and the bracket 3.

### FIELD OF THE INVENTION

The present invention relates to a brake caliper of the floating type, as well as a pad-holding pin and sliding guide assembly.

### BACKGROUND ART

In a disc brake of the floating brake caliper type, the brake caliper comprises a support structure or bracket and a caliper body slidably mounted on the support structure by means of suitable sliding guides. The support structure or bracket is adapted to be mounted on a fixed portion of the vehicle. The brake caliper is generally arranged straddling the external peripheral margin of a brake disc, in which the brake disc is adapted to rotate about a rotation axis (X-X) defining an axial direction (A-A). The sliding movement, or floating movement of the brake caliper in installed condition is parallel to the rotation axis of the brake disc (X-X) along the axial direction (A-A). In addition, in a disc brake a radial direction (R-R) is defined, substantially orthogonal to said axial direction (A-A).

Generally, the caliper body, i.e., the floating structure, comprises a lateral portion, arranged externally to the support structure (generally on the hub side of the braking system), and featuring a housing seat for thrust means or pistons, and a cantilevered or bracing portion, extending from the lateral portion in axial direction (towards the wheel side) on the support structure or bracket.

The brake caliper slidingly carries two brake pads joined together. The brake pads may be arranged inside a housing obtained in the support structure and/or supported by pad-holding pins connected to the caliper body and/or the support structure so that they may come into contact with the braking surfaces of the disc.

A first brake pad, or active brake pad or active side brake pad, is pushed against the disc directly by thrust means, or pistons, housed in the lateral portion of the caliper body. A second brake pad, or reaction brake pad, opposed to the first brake pad, is pushed against the disc by the cantilevered or bracing portion of the caliper body during the sliding of the caliper body with respect to the support structure or bracket following the reaction resulting from the interaction between the first pad and the disc. During the braking operations, the pads are guided to slide on the pad-holding pins, and the pad-holding pins form a reaction constraint for the brake pads onto which the braking forces due to contact between the brake pads and the brake disc may be discharged.

The brake pads comprise pad connecting portions and/or abutment portions with the pad-holding pins. In some solutions, the pad connecting portions are a pair of eyelets passing through the respective brake pad plate supporting the friction material. In other solutions, the pad connecting portions are appendages shaped so as to contact and abut the pad-holding pin.

In some solutions, at least one of the pad-holding pins is configured to support and/or provide a support for one of the two brake pads. In other solutions, the pad-holding pin is configured to support and/or provide a support for both of the two brake pads.

In some known solutions, the sliding guide is fixed to the bracket and slides in a seat of the caliper body.

Solutions are also known, in which the sliding guide and the pad-holding pin are integrated to form a pad-holding pin and sliding guide assembly.

From document JP2011069388, making pad-holding pin and sliding guide assemblies is known, comprising the sliding guide and the pad-holding pin made in one piece, and a threaded portion arranged between the sliding guide and the pad-holding pin configured so as to create a threaded connection with a threaded bracket seat. In this solution, the pad-holding pin and sliding guide assembly comprises a longitudinal body which tapers as it passes from the sliding guide to the pad-holding pin, in which the diameter of the sliding guide is greater than the diameter of the threaded portion, which is in turn greater than the diameter of the pad-holding pin. Thereby, the pad-holding pin may be inserted into the sliding seat made in the caliper body on the side of the first caliper body portion or on the side of the vehicle and pass at least partially through the bracket seat until the threaded portion is constrained to the bracket.

With this solution, during maintenance operations, for example during a brake pad replacement, it is necessary to completely separate the pad-holding pin and sliding guide assembly from the brake caliper, so as to remove the pads from the respective pad-holding pins and be able to reposition new ones, completely reassembling the pad-holding pin and sliding guide assembly. This operation is both time-consuming and it may involve risks of contamination with dusts at the sliding seats of the caliper body, since it is necessary to completely extract the sliding guides from the respective sliding seats thereof and reassemble them subsequently, after changing the pads.

From document EP1604126, it is instead known to make the pad-holding pin and sliding guide assembly comprising the pad-holding pin and the sliding guide made in separate pieces and connected to each other by means of a threaded connection. In this solution, the pad-holding pin comprises in sequence a pin head configured to be manipulated by a user, a pin connecting portion, and a pad-holding portion configured to support and/or contact at least one brake pad. The pin head, the pin connecting portion, and the pad-holding portion have respective diameters which decrease in steps from the pin head to the pad-holding portion. The sliding guide comprises a guide head, a sliding portion configured to slide within the sliding seat of the caliper body, and a guide connecting portion which is threaded. Externally, the connecting portion has an external pin thread and internally delimits a blind hole with an internal pin thread. The pad-holding pin is connectable to the bracket with a threaded connection by means of the external pin thread of the pin connecting portion. The sliding guide is connectable to the pad-holding pin with a threaded connection by means of the guide connecting portion connected to the internal pin thread. Even though with this solution, during maintenance operations, it is possible to separate the sliding guide from the pad-holding pin, completely avoiding the extraction of the sliding guide from the respective sliding seat, it may accidentally happen that by unscrewing the sliding guide from the pad-holding pin, the pad-holding pin is also partially unscrewed, extending maintenance times in the event that the user notices the unscrewing of the pad-holding pin, forcing the user to screw it back into the bracket.

The need is therefore felt in the sector to produce floating brake caliper solutions and pad-holding pin and sliding guide assembly solutions which allow simplifying the assembly and maintenance of the brake caliper, reducing production costs.

Therefore, it is the issue underlying the present invention to devise a brake caliper of the floating type and a pad-holding pin and sliding guide assembly having structural and functional features such as to meet the aforesaid needs, while obviating the drawbacks mentioned with reference to the prior art and meeting the aforesaid felt needs.

### Solution

It is the object of the present invention to provide a brake caliper of the floating type, as well as a pad-holding pin and sliding guide assembly, which allow simplifying the maintenance and assembly or disassembly operations of the brake caliper, reducing maintenance times, as well as allowing to reduce production costs.

This and other objects and advantages are achieved by a brake caliper and a pad-holding pin and floating guide assembly according to the independent claims.

Some advantageous embodiments are the subject of the dependent claims.

By virtue of the proposed solutions, it is possible to produce a brake caliper at reduced costs, by virtue of the reduction of the processing on the bracket, avoiding threads on the insertion holes of the pad-holding pin and sliding guide assemblies.

By virtue of the proposed solutions, it is possible to produce a pad-holding pin and sliding guide assembly, by virtue of the reduction of the processing on the pad-holding pin and on the sliding guide, limiting the threads to the mutual connection between the pad-holding pin and the sliding guide, avoiding threads on the insertion holes delimited by the bracket.

By virtue of the proposed solutions, it is possible to simplify the maintenance operations of a brake caliper, allowing a decoupling of the pad-holding pin from the sliding guide, which is made easier than known, keeping the sliding guide housed in the sliding seat thereof and separating the pad-holding pin on the side opposite to the portion of the caliper body which delimits the seat for thrust means.

By virtue of the proposed solutions, it is possible to simplify the maintenance operations of the brake caliper and to reduce, if not eliminate, the risk for the sliding portions of the sliding guides to come into contact with liquids or dusts during the pad changing operations.

### FIGURES

Further features and advantages of the brake caliper and of the pad-holding pin and sliding guide assembly will be apparent from the following description of preferred embodiments thereof, given by way of non-limiting example, with reference to the accompanying Figures, in which:

FIG. 1 shows, in an axonometric view on the side opposite to the vehicle, a brake caliper of the floating type according to a first embodiment of the present invention, comprising at least one pad-holding pin and sliding guide assembly according to a first embodiment, preferably a first pad-holding pin and sliding guide assembly and a second pad-holding pin and sliding guide assembly, fixed to the bracket and sliding in the caliper body, in which each pad-holding pin and sliding guide assembly comprises a respective pad-holding pin and a respective sliding guide made in separate pieces and connected to each other by means of a threaded connection by tightening the bracket from opposite sides between the respective pad-holding pin and the respective sliding guide, avoiding making a threaded connection between the bracket and the pad-holding pin and sliding guide assembly, in which the respective pad-holding pin is configured to support both brake pads;

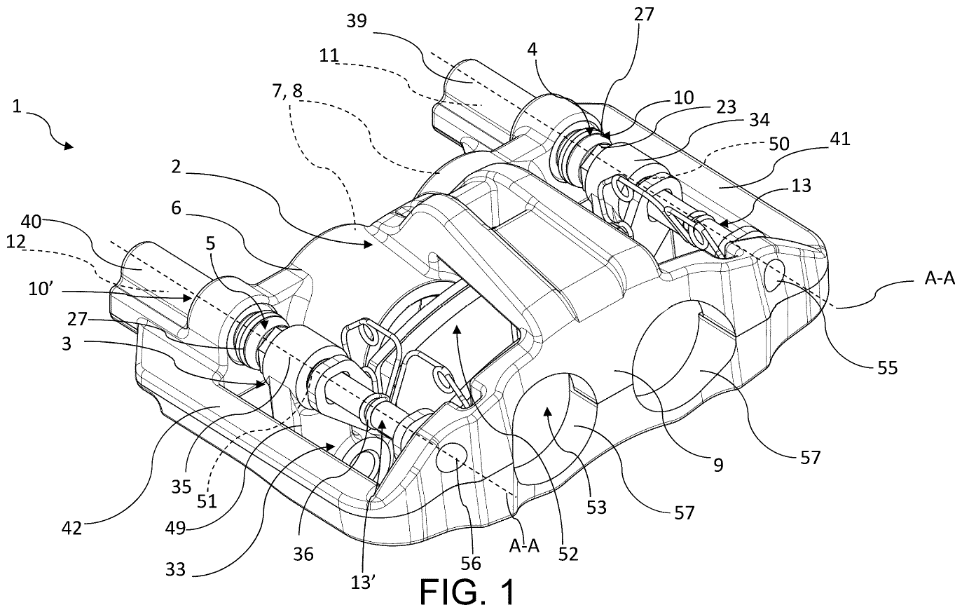

FIG. 2 shows the brake caliper of FIG. 1 in an axonometric view from a side opposite to FIG. 1;

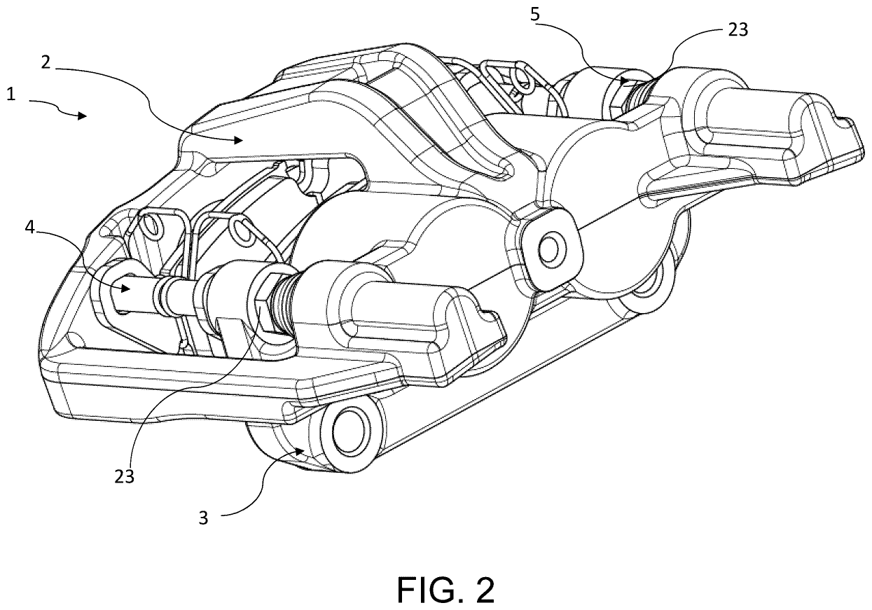

FIG. 3 shows the brake caliper of FIG. 1 in a sectional view parallel to the axial direction and to the radial direction passing through the axis of the at least one pad-holding pin and sliding guide assembly, in which the sliding seat, in which the sliding guide is at least partially housed, is a blind seat, in which the sliding guide is in sliding contact at least partially in a direct manner with the caliper body, and in which the pad-holding pin and sliding guide assembly may be manipulated only on a side opposite to the vehicle;

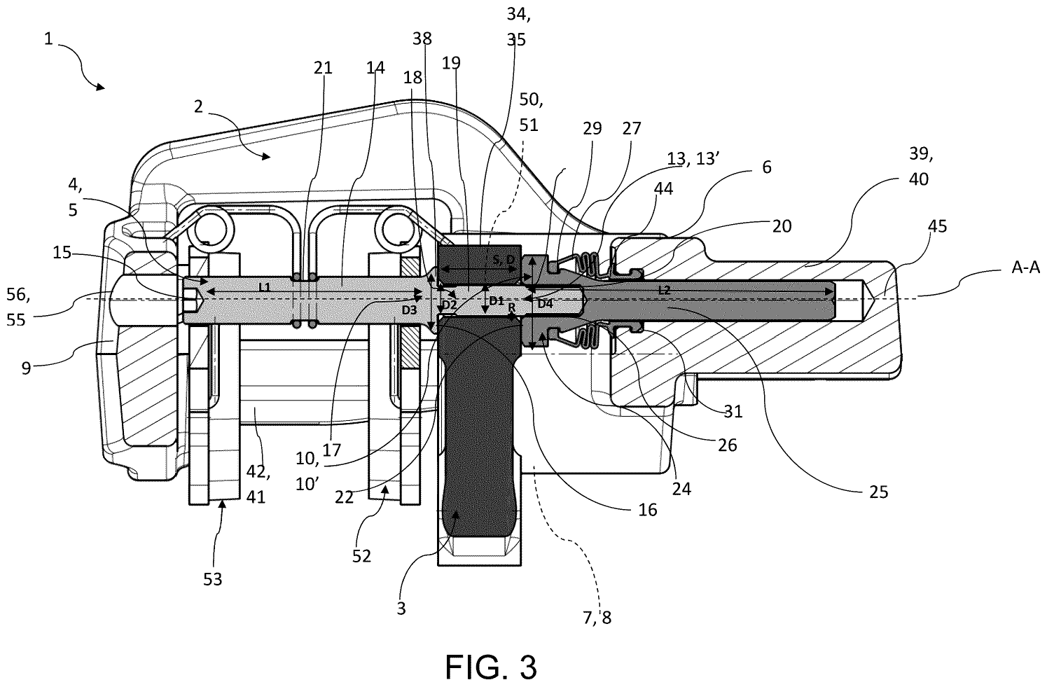

FIG. 4 shows, in an axonometric view on the side opposite to the vehicle, a brake caliper of the floating type according to a second embodiment of the present invention, comprising at least one pad-holding pin and sliding guide assembly according to a second embodiment, in which, as in the first embodiment of FIG. 1, each pad-holding pin and sliding guide assembly comprises a respective pad-holding pin and a respective sliding guide made in separate pieces and connected to each other by means of a threaded connection by tightening the bracket from opposite sides between the respective pad-holding pin and the respective sliding guide, avoiding making a threaded connection between the bracket and the pad-holding pin and sliding guide assembly, in which the respective pad-holding pin is configured to support both brake pads;

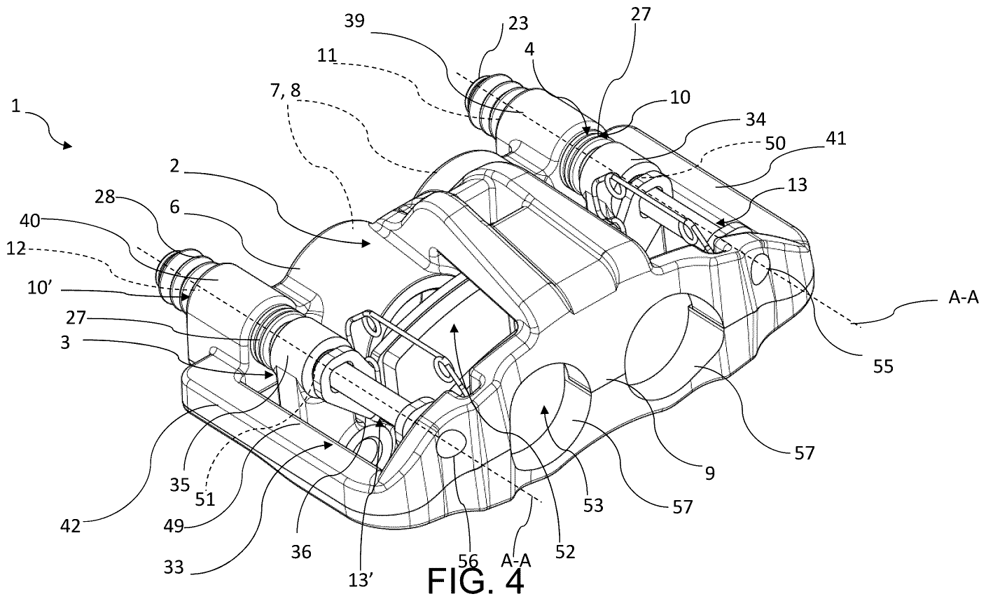

FIG. 5 shows the brake caliper of FIG. 4 in an axonometric view on a side opposite to FIG. 4, i.e., on the side of the vehicle or the vehicle connecting side;

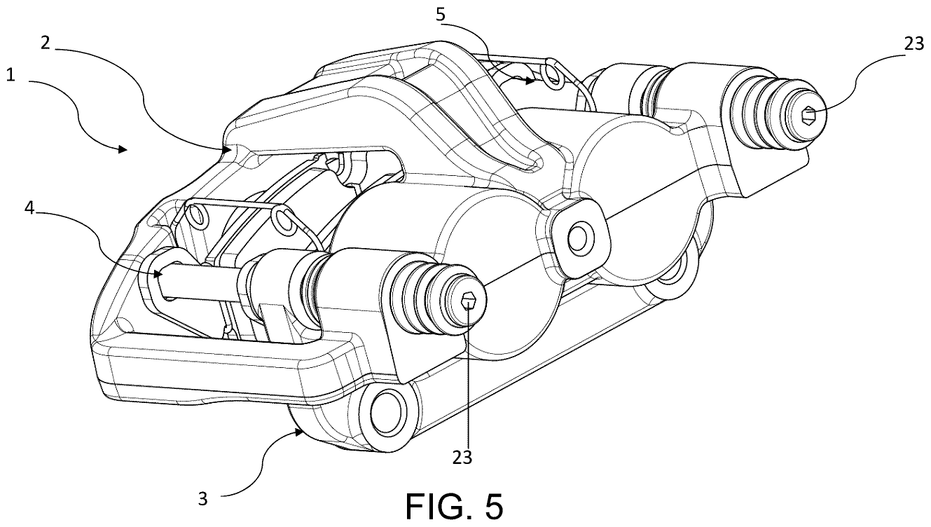

FIG. 6 shows the brake caliper of FIG. 4 in a sectional view parallel to the axial direction and to the radial direction passing through the axis of the at least one pad-holding pin and sliding guide assembly, in which the sliding seat where the sliding guide is at least partially housed, is a through seat, in which the sliding guide is in sliding contact at least partially in a direct manner with the caliper body, in which the sliding guide is connected to the through sliding seat, on one side facing the bracket with a first bellows-like dust-protection gasket and, on the opposite side with a second bellows-like dust-protection gasket, leaving the end of the sliding guide freely accessible to be manipulated by a tool, and in which the pad-holding pin and sliding guide assembly is manipulable both on the side opposite to the vehicle and on the other side;

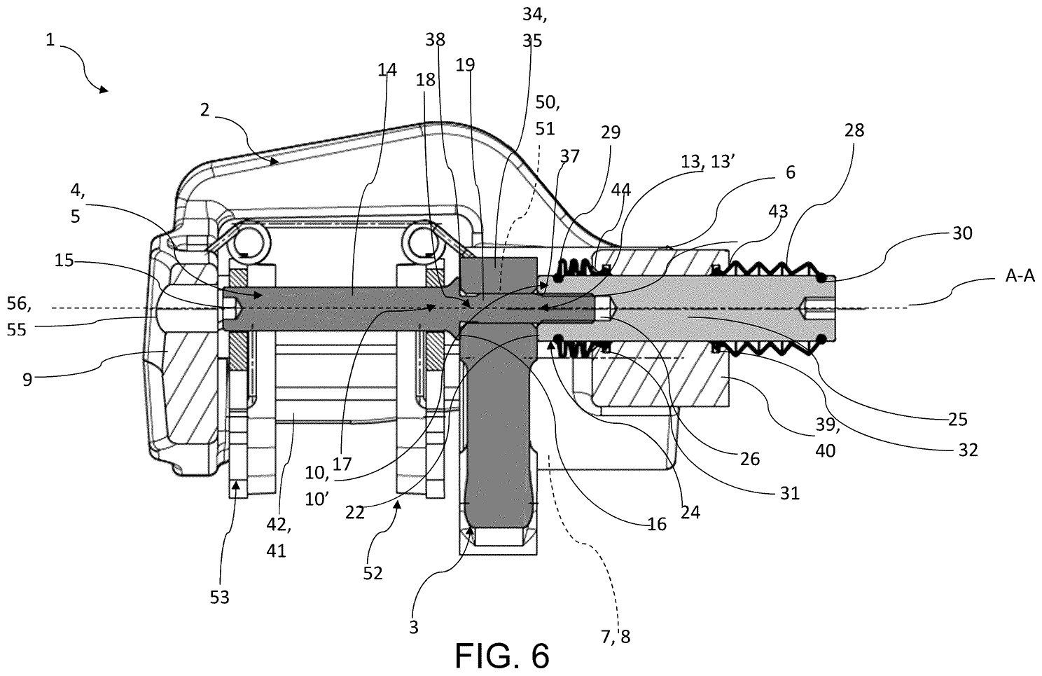

FIG. 7 shows, in an axonometric view on the side opposite to the vehicle, a brake caliper of the floating type according to a second embodiment of the present invention, comprising at least one pad-holding pin and sliding guide assembly according to a second embodiment, in which, as in the first embodiment of FIG. 1 and FIG. 2, each pad-holding pin and sliding guide assembly comprises a respective pad-holding pin and a respective sliding guide made in separate pieces and connected to each other by means of a threaded connection by tightening the bracket from opposite sides between the respective pad-holding pin and the respective sliding guide, avoiding making a threaded connection between the bracket and the pad-holding pin and sliding guide assembly, and in which the respective pad-holding pin is configured to support only one brake pad and in which the brake caliper comprises a pad-holding pin on the side opposite to the vehicle configured to support the other brake pad not supported by the pad-holding pin and sliding guide assembly;

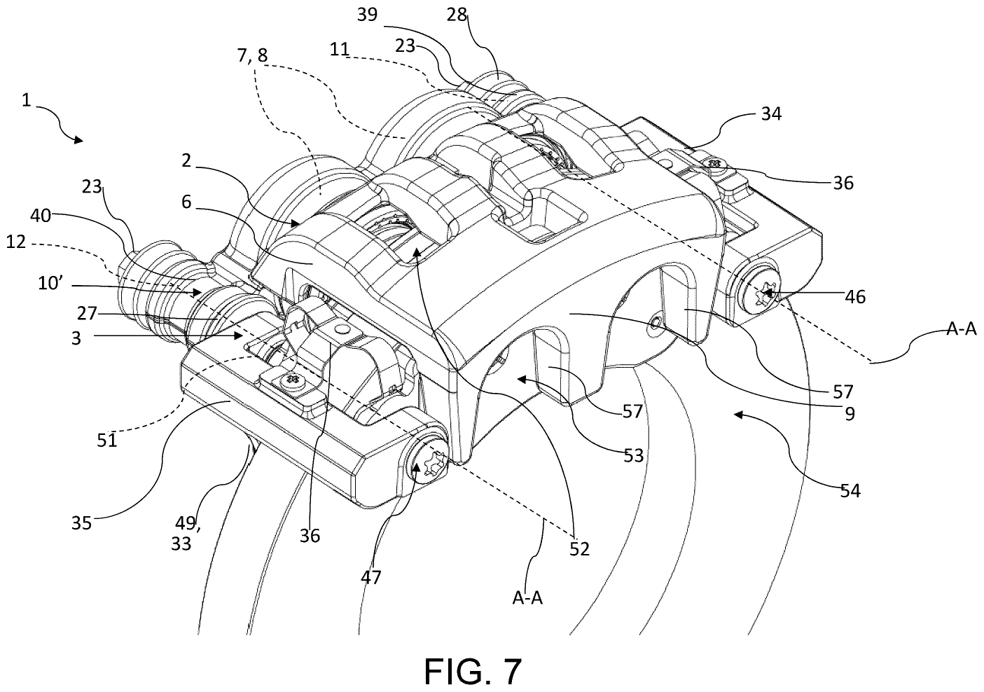

FIG. 8 shows the brake caliper of FIG. 4 in a sectional view parallel to the axial direction and the radial direction passing through the axis of the at least one pad-holding pin and sliding guide assembly.

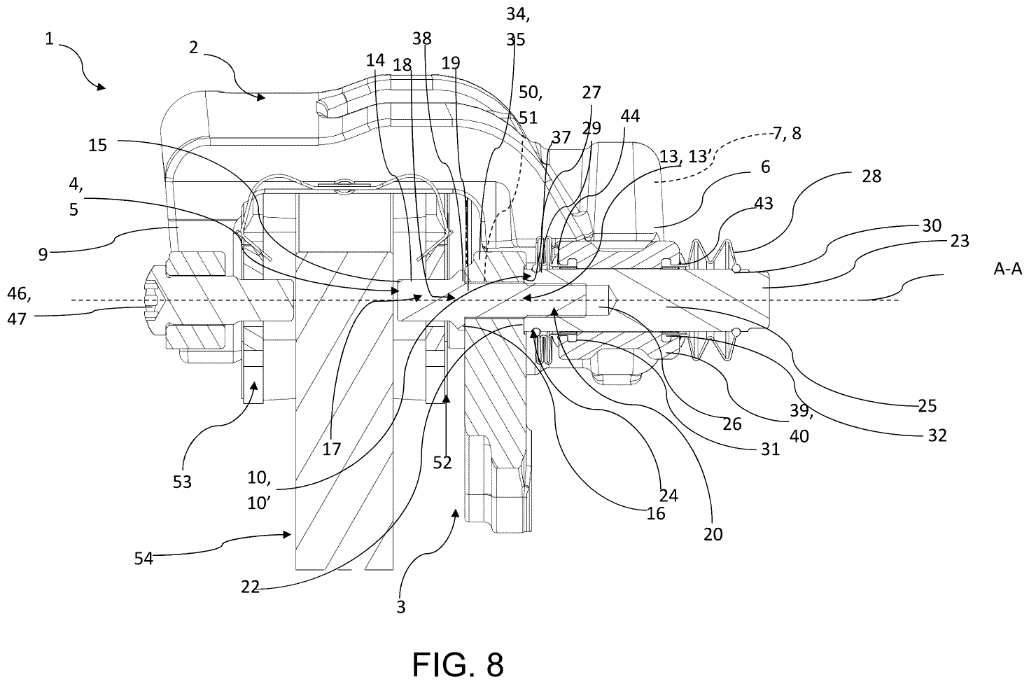

### DESCRIPTION OF SOME PREFERRED EMBODIMENTS

In accordance with a general embodiment, reference numbers 4, 5 indicate a pad-holding pin and sliding guide assembly for a brake caliper 1 of the floating type of a disc brake. The brake caliper 1 comprises a caliper body or floating element 2 and a bracket or support element 3 configured to be connected to a vehicle.

The pad-holding pin and sliding guide assembly 4, 5 may be connected in a fixed manner to the bracket 3 and in a sliding manner to the caliper body 2 to allow for a relative sliding between the caliper body 2 and the bracket 3 along an axial direction A-A.

The pad-holding pin and sliding guide assembly 4, 5 comprises a pad-holding pin 13, 13′ and a sliding guide 10, 10′ made in separate, reversibly connectable pieces.

The pad-holding pin 13, 13′ is configured to support at least one brake pad 52, 53 and the sliding guide 10, 10′ is at least partially housable in a respective sliding seat 11, 12, in which the respective sliding seat 11, 12 is made in said caliper body 2.

Advantageously, the pad-holding pin 13, 13′ and the sliding guide 10, 10′ comprise a pin connecting portion 17 and a guide connecting portion 24, respectively, connectable to each other by threaded connection to connect the pad-holding pin and sliding guide assembly 4, 5 in a fixed manner to the bracket 3 by tightening the bracket 3 on axially opposite sides between the pad-holding pin 13, 13′ and the sliding guide 10, 10′ avoiding having connecting threads between the at least one pad-holding pin and sliding guide assembly 4, 5 and the bracket 3.

Thereby, it is possible to make a fastening between the pad-holding pin and sliding guide assembly 4, 5 and the bracket without threaded connections with the bracket, and therefore without having to make a bracket with a threaded hole, as well as without having to provide threads on the pad-holding pin or on the sliding guide to connect the assembly 4, 5 to the bracket, simplifying the processing and production steps and the assembly steps, since it is not necessary to connect more than one thread to connect the assembly 4, 5 to the bracket 3.

In one embodiment, the pin connecting portion 17 comprises a threaded portion 20 and the guide connecting portion 24 delimits a threaded seat 26, or vice versa, in which the threaded portion 20 and the threaded seat 26 are reversibly connectable by threaded connection.

In one embodiment, said threaded portion 20 and said threaded seat 26 are the only threaded portions of the pad-holding pin and sliding guide assembly 4, 5 configured to connect the pad-holding pin 13, 13′ and the sliding guide 10, 10′ to the bracket 3 avoiding direct threaded connections with the bracket 3. In one embodiment, said threaded portion 20 and said threaded seat 26 are the only threaded portions of the pad-holding pin and sliding guide assembly 4, 5, avoiding providing additional threads for the assembly 4, 5.

In one embodiment, at least one of either the pin connecting portion 17 or the guide connecting portion 24 is at least partially insertable into a bracket through-hole 50, 51 along the axial direction A-A.

In one embodiment, the pin connecting portion 17 comprises a pin abutment portion 16 and in which the guide connecting portion 24 comprises a guide abutment portion 22. In one embodiment, the pin abutment portion 16 and the guide abutment portion 22 are configured to abut against the bracket 3 on axially opposite sides.

In one embodiment, the pin abutment portion 16 and the guide abutment portion 22 face each other in the axial direction A-A when the pad-holding pin 13, 13′ and the sliding guide 10, 10′ are connected to each other.

In one embodiment, the pin abutment portion 16 and the guide abutment portion 22, during the connection between the pad-holding pin 13, 13′ and the sliding guide 10, 10′, are mutually approachable up to a tightening distance D, which is either less than or equal to a bracket thickness S. In one embodiment, the bracket thickness S is defined as the thickness in the axial direction A-A of the bracket 3 in the vicinity of the bracket through-hole 50, 51, preferably between the walls surrounding the openings of the bracket through-hole 50, 51 from axially opposite sides and against which the pad-holding pin 13, 13′ and the sliding guide 10, 10′ may abut.

In one embodiment, the threaded portion 20 and the threaded seat 26 have a thread length such as to prevent the pin abutment portion 16 and the guide abutment portion 22 from abutting against each other.

In one embodiment, the pin connecting portion 17 comprises a pin connecting shaft 17 axially projecting from the pin abutment portion 16. For example, the pin abutment portion 16 forms a crown wall from which the pin connecting shaft 17 projects.

In one embodiment, the pin connecting shaft 17 comprises a first shaft portion 19 and said threaded portion 20. In one embodiment, the threaded portion 20 forms a free end of said pin connecting shaft 17.

In one embodiment, the first shaft portion 19 is configured to be housed with radial clearance R in the respective bracket through-hole 50, 51 avoiding threaded connections with the bracket 3.

In one embodiment, the pad-holding pin 13, 13′ comprises a pad-holding shaft 14 configured to support said at least one brake pad 52, 53. In one embodiment, the pad-holding pin 13, 13′ comprises a pin manipulation seat 15, configured to be manipulated by a user to connect the pad-holding pin 13, 13′ to the sliding guide 10, 10′. For example, the pin manipulation seat 15 is arranged at an axial end of the pad-holding shaft 14, at a head of the pad-holding pin 13, 13′. In one embodiment, the pin manipulation seat 15 is a blind seat inside the pad-holding pin 13, 13′ delimited by a grooved profile or it is an outer polygonal geometric profile, for example a hexagonal geometric profile, which delimits a portion of the pad-holding pin 13,13′, for example a free end of the pad-holding pin opposite to the threaded portion 20.

In one embodiment, the pin abutment portion 16 forms one at least radial wall of the pad-holding shaft 14 on the side opposite to the pin manipulation seat 15.

In one embodiment, said pad-holding shaft 14 has a pad-holding shaft length L1 defined between the pin abutment portion 16 and the other end of the pad-holding shaft 14, and the sliding guide 10, 10′ has a sliding guide length L2 defined between the guide abutment portion 22 and the other end of the sliding guide 10, 10′, in which the pad-holding shaft length L1 is less than the sliding guide length L2.

In one embodiment, said pad-holding shaft 14 is configured to support a single brake pad of said at least one brake pad 52, 53, avoiding projecting from the bracket 3 straddling the brake disc. In one embodiment, said pad-holding shaft 14 is configured to support two brake pads 52, 53 axially opposite to each other, projecting from the bracket 3 straddling the brake disc.

In one embodiment, the pin connecting shaft 17 comprises a maximum shaft diameter D1. In one embodiment, the bracket through-hole 50, 51 has a maximum through-hole diameter D2. In one embodiment, the pin abutment portion 16 has a maximum pin abutment diameter D3. In one embodiment, the guide abutment portion 22 has a maximum guide abutment diameter D4. In one embodiment, the maximum pin abutment diameter D3 and the maximum guide abutment diameter D4 are greater than said maximum hole diameter D2. In one embodiment, the maximum shaft diameter D1 is less than said maximum hole diameter D2 by at least said radial clearance R. Within the present description, maximum diameter of a component means a maximum radial dimension of the component in the radial direction R-R perpendicular to the axial direction.

In one embodiment, the pad-holding shaft 14 delimits a pin groove 21 configured to form a connecting seat for a pad return spring 36 configured to elastically oppose an advancement of the at least one brake pad 52, 53 and to move the at least one brake pad 52, 53 away from the brake disc once a braking action ends. In one embodiment, the pin groove 21 is made at the center and/or at the midpoint of the pad-holding shaft length L1.

In one embodiment, the sliding guide 10, 10′ comprises a guide head and a guide sliding portion 25 configured to be at least partially housed in a sliding manner in the respective sliding seat 11, 12 made in said caliper body 2, in which the guide sliding portion 25 extends from the guide head. In one embodiment, the sliding guide 10, 10′ and/or the guide head is delimited at one end thereof by the guide abutment portion 22.

In one embodiment, the sliding guide 10, 10′ delimits said threaded seat 26 made at least partially inside the guide head and/or the guide sliding portion 25 as a blind cavity having a respective opening, radially surrounded by the guide abutment portion 22.

In one embodiment, the sliding guide 10, 10′ comprises at least one guide manipulation seat 23 at one end of the sliding guide 10, 10′. For example, the guide manipulation seat 23 is made with a grooved profile internally delimited by the guide sliding portion 25 to couple with a tool, for example at the end opposite to the guide head. In one embodiment, the guide manipulation seat 23 is made with a geometric profile which at least partially externally delimits the guide head of the sliding guide 10, 10′ to be coupled to a tool.

In one embodiment, the sliding guide 10, 10′ comprises an anti-rotation profile externally to the end of the sliding guide 10, 10′ at the threaded seat 25. In one embodiment, the anti-rotation profile is configured to be coupled with clearance in an anti-rotation seat made in the bracket 3 which surrounds the bracket through-hole 50, 51 on the side opposite to the pad-holding pin 13, 13′ so as to prevent a rotation of the sliding guide 10, 10′ when screwing the pad-holding pin 13, 13′. In one embodiment, the anti-rotation profile is a hexagonal profile and the anti-rotation seat is a hexagonal profile. In one embodiment, the anti-rotation profile forms at least one of said at least one guide manipulation seat 23. In other words, the anti-rotation profile is configured both to couple with the anti-rotation seat and to be manipulated by a tool so as to block the sliding guide during the connection or during the separation of the pad-holding pin.

In one embodiment, the pad-holding pin and sliding guide assembly 4, 5 comprises at least one bellows-like dust-protection gasket 27, 28 configured to be connected on one side to the sliding guide 10, 10′, for example at a respective guide groove 29, 30, and on the other side to the caliper body 2, for example at a respective sliding seat groove 31, 32 so as to seal the respective sliding seat 11, 12 in a fluid-tight manner. In one embodiment, the pad-holding pin and sliding guide assembly 4, 5 comprises a first bellows-like dust-protection gasket 27 and a second bellows-like dust-protection gasket 28. In one embodiment, the sliding guide 10, 10′ at least partially slides inside the at least one bellows-like dust-protection gasket 27, 28.

In one embodiment, the sliding guide 10, 10′ delimits a first guide groove 29 on the side of the threaded seat 26 and in which the caliper body 2 delimits a first sliding seat groove 31 at one end of the respective sliding seat 11, 12, in which the first bellows-like dust-protection gasket 27 is shaped so as to connect in a fluid-tight manner to the first guide groove 29 and the first sliding seat groove 31.

In one embodiment, the sliding guide 10, 10′ delimits a second guide groove 30 on the side opposite the threaded seat 26 and in which the caliper body 2 delimits a second sliding seat groove 32 at one end of the respective sliding seat 11, 12 opposite to the first sliding seat groove 31, in which the second bellows-like dust-protection gasket 28 is shaped so as to connect in a fluid-tight manner to the second guide groove 30 and the second sliding seat groove 32.

The present invention also concerns a brake caliper of the floating type of a disc brake, in which the brake caliper is generally indicated by reference numeral 1.

The brake caliper 1 comprises a caliper body or floating element 2, a bracket or support element 3 configured to be connected to a vehicle and at least one pad-holding pin and sliding guide assembly 4, 5, in which the at least one pad-holding pin and sliding guide assembly 4, 5 is connected in a fixed manner to the bracket 3 and slidably connected to the caliper body 2 to allow a relative sliding between the caliper body 2 and the bracket 3 along an axial direction A-A.

Each pad-holding pin and sliding guide assembly 4, 5 comprises a respective pad-holding pin 13, 13′ and a respective sliding guide 10, 10′ made in separate, reversibly connectable pieces, in which each pad-holding pin 13, 13′ is configured to support at least one brake pad 52, 53 and in which each sliding guide 10, 10′ is at least partially housed in a respective sliding seat 11, 12, in which the respective sliding seat 11, 12 is made in said caliper body 2.

Advantageously, each respective pad-holding pin 13, 13′ and each respective sliding guide 10, 10′ respectively comprise a pin connecting portion 17 and a guide connecting portion 24 connected to each other by threaded connection, connecting the at least one pad-holding pin and sliding guide assembly 4, 5 in a fixed manner to the bracket 3 by tightening the bracket 3 on axially opposite sides between each respective pad-holding pin 13, 13′ and each respective sliding guide 10, 10′ avoiding having threaded connections between the at least one pad-holding pin and sliding guide assembly 4, 5 and the bracket 3.

In one embodiment, said at least one pad-holding pin and sliding guide assembly 4, 5 is a pad-holding pin and sliding guide assembly 4, 5 according to any one of the embodiments described above.

In one embodiment, the bracket 3 comprises a bracket connecting flange 33 configured to be rigidly connected to a vehicle suspension through connecting means, for example screws or bolts and nuts, avoiding being arranged straddling a brake disc 54.

In one embodiment, the bracket 3 comprises a first bracket connecting portion 34 and a second bracket connecting portion 35, in which each bracket connecting portion 34, 35 delimits a respective bracket through-hole 50, 51 along the axial direction A-A, in which each bracket through-hole 50, 51 extends between a first bracket opening 37 and a second bracket opening 38, in which the first bracket opening 37 faces the first caliper body portion 6 and in which the second bracket opening 38 faces the opposite side.

In one embodiment, each bracket through-hole 50, 51 is a respective insertion seat to partially insert a respective pad-holding pin and sliding guide assembly 4, 5 and fix the pad-holding pin and sliding guide assembly 1 to the bracket 3 by tightening it on axially opposite sides.

In one embodiment, the connecting flange 33 comprises a U-shaped bracket portion 49, in which the first bracket connecting portion 34 and the second bracket connecting portion 35 are arranged at the ends of the U-shaped bracket portion 33.

In one embodiment, the caliper body 2 comprises a first caliper body portion or vehicle-side caliper body portion 6, in which the first caliper body portion 6 delimits a housing seat 7 for thrust means 8. In one embodiment, the caliper body 2 comprises a second caliper body portion or cantilevered caliper body portion 9, in which the second caliper body portion 9 projects from the first caliper body portion 6 at least in the axial direction A-A on an opposite side with respect to the vehicle so that the caliper body 2 is arranged straddling a brake disc 54.

In one embodiment, the first caliper body portion 6 comprises a first caliper body connecting portion 39 and a second caliper body connecting portion 40, in which each caliper body connecting portion 39, 40 delimits a respective caliper body hole which delimits the respective sliding seat 11, 12.

In one embodiment, the respective caliper body hole extends along a direction either parallel to or coincident with the axial direction A-A between a caliper body bracket-side opening 44 and a caliper body bottom wall 45 forming a blind hole.

In one embodiment, the respective caliper body hole extends along a direction either parallel to or coincident with the axial direction A-A between a caliper body bracket-side opening 44 and a caliper body counter-bracket-side opening 43 forming a blind hole.

In one embodiment, the caliper body 2 is shaped so as to form a closed frame around the brake pads 52, 53, so as to mechanically strengthen the caliper body with respect to what is known, in which the caliper body straddles the brake pads without tangentially surrounding them. In one embodiment, the caliper body 2 comprises a first tangential bridge 41 and a second tangential bridge 42 configured to be arranged straddling the brake disc 54 and connecting the first caliper body portion 6 to the second caliper body portion 9 on tangentially opposite sides so that the caliper body forms a closed frame around the brake pads 52, 53.

According to an embodiment, the second caliper body portion 9 comprises at least one processing or front discharge through-opening 57 arranged facing the at least one housing seat 7 for the thrust means 8, which is configured to be crossed by a tool to allow processing the inner surface of the at least one housing seat 7 for the thrust means 8. According to an embodiment, the at least one opening 57 is a circle-shaped opening. According to an embodiment, the at least one opening 57 is a U-shaped opening. According to an embodiment, the at least one opening 57 has a diameter corresponding to the diameter of a cylinder-piston group housed in the housing seat 7. According to an embodiment, the second caliper body portion 9 comprises two of said at least one processing or front discharge through-opening 57, each facing a respective housing seat 7 for thrust means 8. Advantageously, the presence of at least one processing through-opening 57 allows processing the at least one housing seat 5 using standard tools.

In one embodiment, said at least one pad-holding pin and sliding guide assembly 4, 5 comprises a first pad-holding pin and sliding guide assembly 4 and a second pad-holding pin and sliding guide assembly 5. In one embodiment, the first pad-holding pin and sliding guide assembly 4 and the second pad-holding pin and sliding guide assembly 5 have the same geometry and dimensions and/or are mutually interchangeable.

In one embodiment, said at least one pad-holding pin 13, 13′ comprises a first pad-holding pin 13 and a second pad-holding pin 13′, in which each pad-holding pin 13, 13′ is configured to support only the first brake pad 52 avoiding projecting from the bracket 3 straddling the brake disc 54 and in which the brake caliper 1 comprises a first short pin 46 and a second short pin 47 configured to slidably support the second brake pad 53. In one embodiment, the bracket connecting portions 34, 35 are shaped to be arranged transversely to the brake disc from axially opposite sides, in which the first short pin 46 and the second short pin 47 are connected to a bracket portion arranged on the opposite side with respect to the brake disc 54 and facing the bracket hole 50, 51.

In one embodiment, each pad-holding pin 13, 13′ is configured to support two brake pads 52, 53 axially opposite to each other by projecting from the bracket 3 straddling the brake disc, preferably in which each pad-holding pin 13, 13′ is accessible through a respective hole in the second portion of the caliper body 55, 56, preferably a first hole of second caliper body portion 55 and a second hole of second caliper body portion 56, both axially passing through the second caliper body portion 9 and substantially coaxial to the first pad-holding pin 13 and the second pad-holding pin 13′, respectively. In one embodiment, each hole of the second caliper body portion 55, 56 is configured to partially house the respective pad-holding pin 13, 13′ in a state of advanced wear of the brake pad friction material. In fact, during the wear of the friction material of the brake pads, the caliper body 2 moves back and the pad-holding pin 13, 13′ is inserted into the respective hole in the second caliper body portion 55, 56. In one embodiment, the first hole in the second caliper body portion 55 and the second hole in the second caliper body portion 56 each have a maximum diameter which is greater than the maximum diameter of each pad-holding pin 13, 13′. According to an alternative embodiment, the hole in the second caliper body portion 55, 56 may accommodate at least one bearing, preferably a self-lubricating bearing. Such bearing is configured to receive and guide a respective pad-holding pin 13, 13′ so as to increase the rigidity of the caliper body. Thereby, the pad-holding pins 13, 13′, in addition to performing the function of supporting and/or guiding the brake pads, would simultaneously counteract the deformation or twisting of the caliper body 2. According to an embodiment, the end of the pad-holding pin 13, 13′ facing the respective hole in the second caliper body portion 55, 56 comprises a manipulation seat so that the end is accessible through the hole and may be manipulated using a tool which may be inserted through the hole. By virtue of the proposed solutions, it is possible to reduce the processing steps on the pad-holding pin and sliding guide assembly, as well as on the brake caliper.

By virtue of the proposed solutions, it is possible to allow a separation of the pad-holding pin from the bracket, avoiding separating the sliding guide from the caliper body, thus avoiding any possibility of contaminating the sliding seats with liquids or dusts in which the sliding guide is at least partially housed.

By virtue of the proposed solutions, the threads on the pad-holding pin and sliding guide assembly are limited, avoiding direct thread connections with the bracket that could lead to corrosive phenomena.

### LIST OF REFERENCES

1 brake caliper
2 caliper body or floating element
3 bracket or support element
4 first pad-holding pin and sliding guide assembly
5 second pad-holding pin and sliding guide assembly
6 first caliper body portion or vehicle-side caliper body portion
7 housing seat for thrust means
8 thrust means
9 second caliper body portion or cantilevered caliper body portion
10 first sliding guide
10′ second sliding guide
11 first sliding seat
12 second sliding seat
13 first pad-holding pin
13′ second pad-holding pin
14 pin pad-holding shaft
15 pin manipulation seat
16 pin abutment portion
17 pin connecting portion
18 pin connecting shaft
19 first shaft portion
20 threaded portion
21 pin groove
22 guide abutment portion
23 guide manipulation seat
24 guide connecting portion
guide sliding portion
26 threaded seat
27 first bellows-like dust-protection gasket
28 second bellows-like dust-protection gasket
29 first guide groove
30 second guide groove
31 first sliding seat groove
32 second sliding seat groove
33 bracket connecting flange
34 first bracket connecting portion
35 second bracket connecting portion
36 pad return spring
37 first bracket hole opening
38 second bracket hole opening
39 first caliper body connecting portion
40 second caliper body connecting portion
41 first tangential bridge
42 second tangential bridge
43 first caliper body opening or caliper body counter-bracket-side opening
44 second caliper body opening or caliper body bracket-side opening
45 caliper body bottom wall
46 first short pin
47 second short pin
49 U-shaped bracket portion
50 first bracket through-hole or first insertion seat
51 second bracket through-hole or second insertion seat
52 first brake pad
53 second brake pad
54 brake disc
55 first hole in second caliper body portion
56 second hole in second caliper body portion
57 processing or front discharge through-opening
D tightening distance
S bracket thickness
R radial clearance
D1 maximum shaft diameter
D2 maximum through-hole diameter
D3 maximum pin abutment diameter
D4 maximum guide abutment diameter
L1 pad-holding shaft length
L2 sliding guide length

1. A pad-holding pin and sliding guide assembly (4, 5) for a brake caliper (1) of the floating type of a disc brake, wherein the brake caliper (1) comprises a caliper body or floating element (2), a bracket or support element (3) configured to be connected to a vehicle,
wherein the pad-holding pin and sliding guide assembly (4, 5) is connectable in a fixed manner to the bracket (3) and in a sliding manner to the caliper body (2) to allow for a relative sliding between the caliper body (2) and the bracket (3) along an axial direction (A-A),
wherein the pad-holding pin and sliding guide assembly (4, 5) comprises a pad-holding pin (13, 13′) and a sliding guide (10, 10′) made in separate, reversibly connectable pieces,
wherein the pad-holding pin (13, 13′) is configured to support at least one brake pad (52, 53) and wherein the sliding guide (10, 10′) is at least partially housable in a respective sliding seat (11, 12), wherein the respective sliding seat (11, 12) is made in said caliper body (2);
characterized in that
the pad-holding pin (13, 13′) and the sliding guide (10, 10′) comprise a pin connecting portion (17) and a guide connecting portion (24), respectively, connectable to each other by threaded connection to connect the pad-holding pin and sliding guide assembly (4, 5) in a fixed manner to the bracket (3) by tightening the bracket (3) from axially opposite sides between the pad-holding pin (13, 13′) and the sliding guide (10, 10′) avoiding having connecting threads between the at least one pad-holding pin and sliding guide assembly (4, 5) and the bracket (3).

2. A pad-holding pin and sliding guide assembly (4, 5) according to claim 1,
wherein the pin connecting portion (17) comprises a threaded portion (20) and the guide connecting portion (24) delimits a threaded seat (26), or vice versa, wherein the threaded portion (20) and the threaded seat (26) are reversibly connectable by threaded connection,
wherein said threaded portion (20) and said threaded seat (26) are the only threaded portions of the pad-holding pin and sliding guide assembly (4, 5) configured to connect the pad-holding pin (13, 13′) and the sliding guide (10, 10′) to the bracket (3) avoiding direct threaded connections with the bracket (3),
wherein at least one of either the pin connecting portion (17) or the guide connecting portion (24) is at least partially insertable into a bracket through-hole (50, 51) along the axial direction (A-A),
wherein the pin connecting portion (17) comprises a pin abutment portion (16) and wherein the guide connecting portion (24) comprises a guide abutment portion (22),
wherein the pin abutment portion (16) and the guide abutment portion (22) are configured to abut against the bracket (3) from axially opposite sides,
wherein the pin abutment portion (16) and the guide abutment portion (22) face each other in the axial direction (A-A) when the pad-holding pin (13, 13′) and the sliding guide (10, 10′) are connected to each other.

3. A pad-holding pin and sliding guide assembly (4, 5) according to claim 1, wherein the pin abutment portion (16) and the guide abutment portion (22), during the connection between the pad-holding pin (13, 13′) and the sliding guide (10, 10′), are mutually approachable up to a tightening distance (D), which is either less than or equal to a bracket thickness(S),
wherein the threaded portion (20) and the threaded seat (26) have a thread length such to prevent the pin abutment portion (16) and the guide abutment portion (22) from abutting against each other.

4. A pad-holding pin and sliding guide assembly (4, 5) according to claim 2, wherein the pin connecting portion (17) comprises a pin connecting shaft (17) axially projecting from the pin abutment portion (16),
wherein the pin connecting shaft (17) comprises a first shaft portion (19) and said threaded portion (20), wherein the threaded portion (20) forms a free end of said pin connecting shaft (17)
wherein the first shaft portion (19) is configured to be housed with radial clearance (R) in the respective bracket through-hole (50, 51) avoiding threaded connections with the bracket (3).

5. A pad-holding pin and sliding guide assembly (4, 5) according to claim 1, wherein the pad-holding pin (13, 13′) comprises a pad-holding shaft (14) configured to support said at least one brake pad (52, 53).

6. A pad-holding pin and sliding guide assembly (4, 5) according to claim 1,
wherein the pad-holding pin (13, 13′) comprises a pin manipulation seat (15) at an axial end of the pad-holding shaft (14) configured to be manipulated by a user to connect the pad-holding pin (13, 13′) to the sliding guide (10, 10′),

7. A pad-holding pin and sliding guide assembly (4, 5) according to claim 6, wherein the pin manipulation seat (15) is a blind seat inside the pad-holding pin (13, 13′) delimited by a grooved profile or wherein the pin manipulation seat (15) is an outer polygonal geometric profile that delimits the pad-holding pin (13, 13′).

8. A pad-holding pin and sliding guide assembly (4, 5) according to claim 6,
wherein the pin abutment portion (16) forms one at least radial wall of the pad-holding shaft (14) on the side opposite to the pin manipulation seat (15).

9. A pad-holding pin and sliding guide assembly (4, 5) according to claim 5,
wherein said pad-holding shaft (14) has a pad-holding shaft length (L1) defined between the pin abutment portion (16) and the other end of the pad-holding shaft (14), wherein the sliding guide (10, 10′) has a sliding guide length (L2) defined between the guide abutment portion (22) and the other end of the sliding guide (10, 10′),
wherein the pad-holding shaft length (L1) is less than the sliding guide length (L2), wherein said pad-holding shaft (14) is configured to support only one brake pad of said at least one brake pad (52, 53) avoiding projecting from the bracket (3) straddling the brake disc, or
wherein said pad-holding shaft (14) is configured to support two brake pads (52, 53) axially opposite to each other by projecting from the bracket (3) straddling the brake disc.

10. A pad-holding pin and sliding guide assembly (4, 5) according to claim 5,
and/or wherein the pin connecting shaft (17) comprises a maximum shaft diameter (D1),
wherein the bracket through-hole (50, 51) has a maximum through-hole diameter (D2),
wherein the maximum shaft diameter (D1) is less than said maximum hole diameter (D2) by at least said radial clearance (R), wherein the pin abutment portion (16) has a maximum pin abutment diameter (D3), wherein the guide abutment portion (22) has a maximum guide abutment diameter (D4), wherein the maximum pin abutment diameter (D3) and the maximum guide abutment diameter (D4) are greater than said maximum hole diameter (D2).

11. A pad-holding pin and sliding guide assembly (4, 5) according to claim 5,
wherein the pad-holding shaft (14) delimits a pin groove (21) configured to form a connecting seat for a pad return spring (36) configured to elastically oppose an advancement of the at least one brake pad (52, 53) and to move the at least one brake pad (52, 53) away from the brake disc, once a braking action ends.

12. A pad-holding pin and sliding guide assembly (4, 5) according to claim 2, wherein the sliding guide (10, 10′) comprises a guide head and a guide sliding portion (25) configured to be at least partially housed in a sliding manner in the respective sliding seat (11, 12) made in said caliper body (2), wherein the guide sliding portion (25) extends from the guide head,
wherein the sliding guide (10, 10′), and/or the guide head, is delimited at one end thereof by the guide abutment portion (22),
wherein the sliding guide (10, 10′) delimits said threaded seat (26) made at least partially inside the guide head and/or the guide sliding portion (25) as a blind cavity having a respective opening radially surrounded by the guide abutment portion (22),
wherein the sliding guide (10, 10′) comprises at least one guide manipulation seat (23) at one end of the sliding guide (10, 10′), for example made with a grooved profile internally delimited by the sliding guide portion (25) to be coupled to a tool at the end opposite to the sliding guide head or a geometric profile which at least externally partially delimits the guide head of the sliding guide (10, 10′) to be coupled to a tool.

13. A pad-holding pin and sliding guide assembly (4, 5) according to claim 12, wherein the sliding guide (10, 10′) comprises an anti-rotation profile outside the end of the sliding guide (10, 10′) at the threaded seat (25), wherein the anti-rotation profile is configured to be coupled with clearance in an anti-rotation seat made in the bracket (3) which surrounds the bracket through-hole (50, 51) on the side opposite to the pad-holding pin (13, 13′) so as to prevent the sliding guide (10, 10′) from rotating when screwing the pad-holding pin (13, 13′).

14. A pad-holding pin and sliding guide assembly (4, 5) according to claim 13, wherein the anti-rotation profile is a hexagonal profile and the anti-rotation seat is a hexagonal profile, preferably wherein the anti-rotation profile forms at least one of said at least one guide manipulation seat (23).

15. A pad-holding pin and sliding guide assembly (4, 5) according to claim 1, wherein the pad-holding pin and sliding guide assembly (4, 5) comprises at least one bellows-like dust-protection gasket (27, 28), preferably a first bellows-like dust-protection gasket (27) and a second bellows-like dust-protection gasket (28), configured to be connected on one side to the sliding guide (10, 10′), preferably at a respective guide groove (29, 30), and on the other side to the caliper body (2), preferably at a respective sliding seat groove (31, 32) so as to seal the respective sliding seat (11, 12) in a fluid-tight manner, wherein the slide guide (10, 10′) at least partially slides inside the at least one bellows-like dust-protection gasket (27, 28),
preferably wherein the sliding guide (10, 10′) delimits a first guide groove (29) on the side of the threaded seat (26) and wherein the caliper body (2) delimits a first sliding seat groove (31) at one end of the respective sliding seat (11, 12), wherein the first bellows-like dust-protection gasket (27) is shaped so as to connect in a fluid-tight manner to the first guide groove (29) and the first sliding seat groove (31),
preferably wherein the sliding guide (10, 10′) delimits a second guide groove (30) on the side opposite to the threaded seat (26) and wherein the caliper body (2) delimits a second sliding seat groove (32) at one end of the respective sliding seat (11, 12) opposite to the first sliding seat groove (31), wherein the second bellows-like dust-protection gasket (28) is shaped so as to connect in a fluid-tight manner to the second guide groove (30) and the second sliding seat groove (32).

16. A brake caliper (1) of the floating type of a disc brake comprising
a caliper body or floating element (2),
a bracket or support element (3) configured to be connected to a vehicle,
at least one pad-holding pin and sliding guide assembly (4, 5), wherein the pad-holding pin and sliding guide assembly (4, 5) is connected in a fixed manner to the bracket (3) and in a sliding manner to the caliper body (2) to allow for a relative sliding between the caliper body (2) and the bracket (3) along an axial direction (A-A),
wherein each pad-holding pin and sliding guide assembly (4, 5) comprises a respective pad-holding pin (13, 13′) and a respective sliding guide (10, 10′) made in separate, reversibly connectable pieces, wherein each pad-holding pin (13, 13′) is configured to support at least one brake pad (52, 53) and wherein each sliding guide (10, 10′) is at least partially housed in a respective sliding seat (11, 12), wherein the respective sliding seat (11, 12) is made in said caliper body (2);
characterized in that
each respective pad-holding pin (13, 13′) and each respective sliding guide (10, 10′) comprise a pin connecting portion (17) and a guide connecting portion (24) respectively, mutually connected by threaded connection,
connecting the at least one pad-holding pin and sliding guide assembly (4, 5) in a fixed manner to the bracket (3) by tightening the bracket (3) from axially opposite sides between each respective pad-holding pin (13, 13′) and each respective sliding guide (10, 10′) avoiding having threaded connections between the at least one pad-holding pin and sliding guide assembly (4, 5) and the bracket (3).

17. A brake caliper (1) according to claim 16,
wherein said at least one pad-holding pin and sliding guide assembly (4, 5) is a pad-holding pin and sliding guide assembly (4, 5),
wherein the pad-holding pin and sliding guide assembly (4, 5) is connectable in a fixed manner to the bracket (3) and in a sliding manner to the caliper body (2) to allow for a relative sliding between the caliper body (2) and the bracket (3) along an axial direction (A-A),
wherein the pad-holding pin and sliding guide assembly (4, 5) comprises a pad-holding pin (13, 13′) and a sliding guide (10, 10′) made in separate, reversibly connectable pieces,
wherein the pad-holding pin (13, 13′) is configured to support at least one brake pad (52, 53) and wherein the sliding guide (10, 10′) is at least partially housable in a respective sliding seat (11, 12), wherein the respective sliding seat (11, 12) is made in said caliper body (2);
characterized in that
the pad-holding pin (13, 13′) and the sliding guide (10, 10′) comprise a pin connecting portion (17) and a guide connecting portion (24), respectively, connectable to each other by threaded connection to connect the pad-holding pin and sliding guide assembly (4, 5) in a fixed manner to the bracket (3) by tightening the bracket (3) from axially opposite sides between the pad-holding pin (13, 13′) and the sliding guide (10, 10′) avoiding having connecting threads between the at least one pad-holding pin and sliding guide assembly (4, 5) and the bracket (3).

18. A brake caliper (1) according to claim 16, comprising said at least one brake pad (52, 53), wherein said at least one brake pad (52, 53) is supported by each pad-holding pin (13, 13′).

19. Brake caliper (1) according to claim 16, wherein
the bracket (3) comprises a bracket connecting flange (33) configured to be rigidly connected to a vehicle suspension through connecting means, for example screws or bolts and nuts, avoiding being arranged straddling a brake disc (54),
wherein the bracket (3) comprises a first bracket connecting portion (34) and a second bracket connecting portion (35), wherein each bracket connecting portion (34, 35) delimits a respective bracket through-hole (50, 51) along the axial direction (A-A), wherein each bracket through-hole (50, 51) extends between a first bracket opening (37) and a second bracket opening (38), wherein the first bracket opening (37) faces the first caliper body portion (6) and wherein the second bracket opening (38) faces the opposite side,
wherein each bracket through-hole (50, 51) is a respective insertion seat to partially insert a respective pad-holding pin and sliding guide assembly (4, 5) and to fix the pad-holding pin and sliding guide assembly (1) to the bracket (3) by tightening it on axially opposite sides,
wherein the connecting flange (33) comprises a U-shaped bracket portion (49), wherein the first bracket connecting portion (34) and the second bracket connecting portion (35) are arranged at the ends of the U-shaped bracket portion (33).
